(19) United States
(12) Patent Application Publication
(10) Pub. No.: US 2013/0280463 A1
(43) Pub. Date: Oct. 24, 2013

(54) DISPLAY PROTECTOR FOR CONSUMER PRODUCTS WITH CUSTOMIZABLE APPEARANCE AND METHODS RELATING TO SAME

(71) Applicant: SKINIT, INC., San Diego, CA (US)

(72) Inventors: Peter M. On, Encinitas, CA (US); Yen F. Chang, La Jolla, CA (US); Xin Fan, San Diego, CA (US); Darryl R. Kuhn, San Diego, CA (US); Benjamin R. Polomsky, Vista, CA (US); Frank M. Tyneski, San Diego, CA (US)

(73) Assignee: Skinit, Inc., San Diego, CA (US)

(21) Appl. No.: 13/866,797

(22) Filed: Apr. 19, 2013

Related U.S. Application Data
(60) Provisional application No. 61/636,468, filed on Apr. 20, 2012.

(51) Int. Cl. B32B 3/10

(52) U.S. Cl. CPC B32B 3/10
USPC 428/38; 29/428

(57) ABSTRACT

Covers for consumer products and various methods are described herein. In one embodiment, a cover for a consumer product comprises a film substrate configured to cover at least a portion of a surface of the consumer product, the surface including a display screen, the film substrate being at least partially light transmissive and comprising a window portion configured to allow at least a portion of the display screen to be at least partially viewable therethrough; and an image layer on another portion of the film substrate, the image layer configured to at least partially obscure an original appearance of the surface covered by the other portion of the film substrate. The film substrate and image layer cooperate to cover and protect the display screen and decorate the consumer product.

This application claims the benefit of U.S. Provisional Application No. 61/636,468, filed Apr. 20, 2012, entitled DISPLAY PROTECTOR FOR CONSUMER PRODUCTS WITH CUSTOMIZABLE APPEARANCE AND METHODS RELATING TO SAME, which is incorporated in its entirety herein by reference.

### BACKGROUND OF THE INVENTION

1. Field of the Invention

The present invention relates generally to methods and apparatus for protecting and detailing or customizing products, and more specifically to methods and apparatus for protecting and detailing or customizing an appearance of consumer products.

2. Discussion of the Related Art

Many consumer products, (e.g., mobile phones, laptops, notepad or tablet computers, personal digital assistants, personal audio devices, DVD players, game consoles, handheld electronics, etc.), leave the display or screen of the product exposed and susceptible to soiling (e.g., such as smudging or clouding due to oil, dirt and/or grime from fingertips, spatter, spillage, etc.) and/or damage (e.g., such as marring, scratching, cracking or shattering, etc.). In order to protect the displays or screens of consumer products from such soiling and/or damage, many use clear screen protectors to provide a protective layer or coating over the display or screen which prevents some soiling and/or damage from being done to directly to the display of the consumer product and can be cleaned off or replaced when such soiling or damage occurs to the screen protector itself These clear screen protectors usually connect to and cover the display or screen by electrostatic charge or static electricity (e.g., static cling), or through the use of translucent adhesives.

Some drawbacks to such screen protectors are that they are often hard to align or position on the product screen and often come in universal shapes or sizes and require the person installing the screen protector to cut or trim the screen protector to the desired size. This is often hard to do and leads to either a misaligned screen protector wherein a portion of the screen is left exposed or a screen protector that is not cut or trimmed to the appropriate size.

In addition to screen protectors, many consumers desire to further customize their consumer product by applying adhesive covers (aka “skins”) to the exterior of the product allow consumers to customize or personalize such products, not only to help the consumer distinguish his or her product from other similar looking products, but also to allow the consumer to make his or her product their own in special and unique ways, such as by selecting a specific color scheme, design, message or slogan, etc. to display on their product. Skins also provide a level of protection for the exterior surface of the consumer product they cover and protect such products from damage such as marring, scratching, chipping, etc.

Some drawbacks to such skins is that they must be cut or trimmed so that they do not interfere with the display and inputs of the device and must allow sufficient room for clear screen protectors like those mentioned above to be applied to the consumer product. This often requires the trimming to be done when manufacturing the skin because of the many small cutouts that have to be done to accommodate inputs, such as buttons and keys. The actual application of the skin to the consumer product is typically done by the consumer or other individual, which can lead to the misapplication of the skin thereby leaving gaps between the skin and the screen protector. Gaps can collect dirt or other particulates and generally make the appearance of the consumer product less than desirable.

Furthermore, some consumers prefer to use a screen protector together with a skin to decorate their product. The user obtains a screen protector to cover and protect the display screen of the product, and separately obtains an adhesive skin to cover and decorate other portions of the product. An example of the use of screen protectors together with adhesive skins is shown in U.S. Publication No. 2010/0270189 to Pedersen, which is incorporated herein by reference. However, gaps may be formed between the skin and the screen protector if either is not precisely cut and/or due to the geometry of the product. Gaps can collect dirt or other particulates and generally make the appearance of the consumer product less than desirable (e.g., giving the consumer product the appearance of being dirty or grimy due to a buildup of dirt, lint or the like in the gap between the screen protector and the skin) and, in some cases, may leave portions of the display or screen exposed and susceptible to soiling and/or damage.

### SUMMARY OF THE INVENTION

Several embodiments provide covers for consumer products and various methods. In one embodiment, a cover for a consumer product comprises a film substrate configured to cover at least a portion of a surface of the consumer product, the surface including a display screen, the film substrate being at least partially light transmissive and comprising a window portion configured to allow at least a portion of the display screen to be at least partially viewable therethrough; and an image layer on another portion of the film substrate, the image layer configured to at least partially obscure an original appearance of the surface covered by the other portion of the film substrate. The film substrate and image layer cooperate to cover and protect the display screen and decorate the consumer product.

In another embodiment, a method comprises: obtaining a film substrate that will cover at least a portion of a surface of a consumer product, the surface including a display screen, the film substrate being at least partially light transmissive and comprising a window portion configured to allow at least a portion of the display screen to be at least partially viewable therethrough; and applying an image layer on another portion of the film substrate, the image layer configured to at least partially obscure an original appearance of the surface covered by the other portion of the film substrate; wherein the film substrate and image layer will cooperate to cover and protect the display screen and decorate the consumer product.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1A illustrates a layering diagram of an integral screen protector and decorative film cover to be applied to and protect a surface of a consumer product having a display screen according to some embodiments.

FIG. 1B illustrates the layering diagram of the integral screen protector and decorative film cover of FIG. 1A having been applied to the surface of the consumer product according to some embodiments.

FIGS. 2A-2B are perspective views of an exemplary consumer product and an integral screen protector and decorative film cover in accordance with at least one embodiment, illustrating the cover exploded from the consumer product and attached to the consumer product, respectively.

FIGS. 3A-3B are perspective views of another exemplary consumer product and an integral screen protector and decorative film cover in accordance with at least one embodiment, illustrating the cover exploded from the consumer product and attached to the consumer product, respectively.

FIGS. 4A-4B are illustrations of an integral screen protector and decorative film cover in accordance with at least one embodiment wherein portions of both the display screen and consumer product remain visible therethrough, with FIG. 4A depicting an exemplary layering diagram of such a cover and FIG. 4B depicting a perspective view of an exemplary consumer product protected by such cover.

FIGS. 5A-5B are layering diagrams of an integral screen protector and decorative film cover in accordance with some embodiments in which decorative imagery is applied to a reverse side or back side of an at least partially light transmissive structure or layer, with the cover being exploded from and connected to the consumer product, respectively.

FIGS. 6A-6B are perspective views of an integral screen protector and decorative film cover in accordance with at least one embodiment with the cover exploded from and connected to the exemplary consumer product, respectively, and illustrating an exemplary image that covers at least a portion of the display screen to customize the appearance of the screen with a non-functional design element.

FIGS. 7A-7B are perspective views of an integral screen protector and decorative film cover in accordance with another embodiment with the cover exploded from and connected to the exemplary consumer product, respectively, and illustrating an exemplary image that covers at least a portion of the display screen to customize the appearance of the screen with a functional design element.

FIGS. 8A-8B are perspective views of an integral screen protector and decorative film cover in accordance with at least one embodiment with the cover exploded from and connected to another exemplary consumer product, respectively, and illustrating an exemplary image that covers at least a portion of the display screen to customize the appearance of the screen with a non-functional design element.

FIGS. 9A-9B are perspective views of an integral screen protector and decorative film cover in accordance with another embodiment with the cover exploded from and connected to the other exemplary consumer product, respectively, and illustrating an exemplary image that covers at least a portion of the display screen to customize the appearance of the screen with a functional design element.

FIGS. 10A-10B are front elevation views of an integral screen protector and decorative film cover in accordance with another embodiment, the cover illustrated by itself and as applied to an exemplary consumer product, respectively, where an exemplary image covers at least a portion of the consumer product and display screen.

FIGS. 11A-11B are front elevation views of an integral screen protector and decorative film cover in accordance with another embodiment, the cover illustrated by itself and as applied to an exemplary consumer product, respectively, where an exemplary image covers at least a portion of the display screen to enhance or limit function/usability of the consumer product in some desired way.

FIGS. 12A-12B are front elevation views of an integral screen protector and decorative film cover in accordance with another embodiment, the cover illustrated by itself and as applied to an exemplary consumer product, respectively, where an exemplary image surrounds the display screen but not obscure the appearance of all non-display screen portions covered by the cover.

FIGS. 13A-13B are front and back perspective views of an integral screen protector and decorative film cover having a design and/or imagery that cooperates imagery on a corresponding case or other accessory for, or panel or part of, an exemplary consumer product according to some embodiments.

FIG. 14 is a back side perspective view of an exemplary consumer product having a decorative film cover applied to a back surface of the product, the film cover having a design and/or imagery that cooperates imagery on a corresponding integral screen protector and decorative film cover for the consumer product such as shown in FIGS. 12A and 12B according to some embodiments.

FIGS. 15A-15C illustrate perspective views of a notebook style computer product having a display screen, a corresponding integral screen protector and decorative film cover separated from and coupled to the computer product, in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Lastly, although these drawing figures are illustrated as layering diagrams, it should be understood that they could just as easily be illustrated as cross sections of design structures by simply adding cross-hatching to distinguish one layer from another.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “one or more embodiments”, “some embodiments”, or similar language means that a particular feature, structure, or characteristic described in connection with the embodiment/s is included in at least one embodiment of the present invention. Thus, appearances of the phrases “in one embodiment,” “in an embodiment,” “one or more embodiments”, “some embodiments” and similar language throughout this specification may, but do not necessarily, all refer to the same embodiment. In addition, the term “image” or “imagery”, as used herein, refers to any visual depiction including but not limited to one or more of colors, text, names, slogans, images, patterns, designs, textures, graphics, photographs, logos, advertisements, brands, marks or any combination thereof including multiple of each type of design if desired. Images may be provided by a customer or person who wishes to customize a product or may be provided by a manufacturer of the design structure or any other entity.

Furthermore, the described features, structures, or characteristics of embodiments of the invention may be combined in any suitable manner in one or more embodiments. In the following description and the materials incorporated by reference, numerous specific details are provided to provide a thorough understanding of embodiments of the invention. One skilled in the relevant art will recognize, however, that embodiments of the invention can be practiced without one or more of the specific details, or with other methods, components, materials, and so forth. In other instances, well-known structures, materials, or operations are not shown or described in detail to avoid obscuring aspects of embodiments of the invention.

Several embodiments are disclosed herein for apparatus and methods relating to customizing consumer products that address one or more of the problems referred to above and/or other problems and needs not specifically mentioned herein. In some embodiments, combined or integral screen protector and decorative film covers are described to be applied to and protect surface/s of a consumer products having display screen/s. In some embodiments, this eliminates the need to cut or trim the screen protector to size and align the screen protector or separate decorative skin with one another to ensure a proper fit between these components themselves, as well as these components and the consumer product and its features (e.g., displays, inputs, speakers, microphones, power jacks, interface ports, etc.). In some embodiments, a substrate of the integral screen protectors and decorative film covers may be printed or painted on a top or primary surface/side thereof or printed/painted on a secondary surface or through-side of the cover. Methods associated with manufacturing and assembling such integral screen protector and decorative film covers are also disclosed herein.

In some embodiments, an integrated screen protector and decorative cover for a consumer product is provided that includes a film substrate configured to cover at least a portion of a surface of the consumer product, the surface including a display screen, the film substrate being at least partially light transmissive and comprising a window portion configured to allow at least a portion of the display screen to be at least partially viewable therethrough. The cover also includes an image layer on another portion of the film substrate, the image layer configured to at least partially obscure an original appearance of the surface covered by the other portion of the film substrate, wherein the film substrate and image layer cooperate to cover and protect the display screen and decorate the consumer product.

In addition to the above-mentioned drawbacks, further drawbacks exist with known consumer product manufacturing due to problems that exist with surface printing. For example, known surface printing can complicate the manufacturing process by requiring additional painting and printing steps, thereby lengthening the amount of time it takes to manufacture the product, and can result in waste when an error occurs in the application of the printing or painting step. For example, many electronic component manufacturers utilize painting or printing steps to apply masks or borders to glass substrates to hide the edges or connections of a screen located below the glass and/or provide a more finished looking or clean looking product. The painting or printing may be done on the under side (or second surface) of a light transmissive substrate such as glass so that the upper surface remains smooth and free of objects and is easier to clean. In other instances, the painting or printing may be on the outer side (or first surface) of the light transmissive substrate, or in still other embodiments, both on the underside and the outer side. Unfortunately, errors can occur during the painting and/or printing steps which often result in the discarding of the substrate to which the painting and/or printing was applied (which, in the case of glass substrates and the like, can be extremely expensive in touch screen/multi-touch screen applications where the glass has already been coated with a conductive material, such as Indium Tin Oxide (ITO) or is polarized, etc.). Thus, to account for this, the manufacturer or provider is forced to incur the expense of such waste and typically has to keep in stock larger quantities of raw materials than would otherwise be needed in order to account for such waste.

Several embodiments provide apparatus and methods for detailing or customizing a product or device with a design structure applied to an unexposed or through surface of the item to accomplish through surface imaging (or second surface imaging). In other embodiments apparatus and methods are disclosed for detailing or customizing a product or device with a design structure or adhesive design applied to an exposed surface of the item to accomplish surface imaging as well as some protective measures.

In some embodiments, the methods and systems provide the above-mentioned types of detailing or customization on a forecasted or predetermined basis, not on an on-demand basis. However, in other embodiments, the methods and systems provide this detailing or customization in an on-demand manner such that devices can be customized as needed for the intended purpose without the need to forecast and carry inventory anticipating demand for the specific customization. Accordingly, in several embodiments, either a manufacturer or an end user/customer can select and customize imagery to be applied to a product or an accessory to the product (such as an at least partially light transmissive, e.g., transparent or translucent, cover, etc.) in order to detail or customize the product for the purposes and preferences of the manufacturer or end customer.

In some embodiments, images may be selected from simple colors and logos meant to depict borders and trademarks of a manufacturer or, in yet other embodiments, images may be selected from available images and designs, licensed artwork (e.g., Disney artwork, various sports leagues artwork, clip art, etc.), or uploaded by users from user computers or computing devices, smart phones or uploaded from other image services, websites, social media sites (e.g., Facebook, Twitter, Flickr, Photobucket, Tumblr, Pinterest, and so on) and players, etc. in order to personalize a consumer product in a manner desired by the end user or purchaser.

In some embodiments, the end customer may be one or more of an individual, an organization, an agency, a company, a retailer, a distributor, an original equipment manufacturer (OEM), a component customizing manufacturer and/or an original design manufacturer (ODM). The device or the accessory of the device may be for the use of the end customer or other purpose, such as for distribution or commercial sale.

The imagery to be applied for customization may also take a variety of forms. For example, in some embodiments, the imagery includes one or more of the following components: color elements, text, size and font elements, language and regional options, photographic elements, graphic images and designs, artwork elements, transparency, texture (printed, painted, molded, or otherwise applied), identification elements such as asset tags and readable codes, logo elements, material choice elements, and coating and surface treatments. In some forms, the imagery is as simple as a border or black (or white or other color) masking used to define a viewable area of a display and/or make a more finished looking product by hiding display connections, cover slight misalignments of components, etc. For example, in some embodiments, borders may be applied to the second surface of the display screen of a telephone, such as the APPLE IPHONE and APPLE IPAD. In other forms, the imagery is a customized design or decoration applied to a skin that is then placed over at least a portion of the consumer product and screen, thereby customizing or personalizing the product while also protecting the product's screen.

Similarly, the products to be customized or personalized can be any physical object, but are preferably objects that may be commercially purchased by consumers and that include a display screen or display area, or other area intended to be viewed by the consumer and not visually blocked from the consumer's view. Devices, portions of devices, accessories for devices and/or their surfaces whether plastic, metal, glass, ceramic, fabric or other material that may be customized include, but are not limited to: consumer electronic devices (mobile handsets, notebook computers, netbook computers, keyboards, tablets, touch screen computing devices, servers, digital music players, etc.) and accessories, electronic and non-electronic medical devices, household products (kitchen appliances, switch plates, tile, ceramics, etc.), tools (cordless drills, saws, tool boxes, etc.), health and beauty products (containers, makeup cases, compacts, hair dryers, curling irons, etc.), automobiles, parts and accessories, jewelry, media cases, sporting equipment, fishing equipment and lures, luggage, apparel, street signage, advertising and bill boards, and furnishings. It is understood that these are only provided by way of example, and that other devices are contemplated.

In some embodiments, such devices are relatively non-unique in appearance relative to other commercially available devices from the same and other manufacturers. For example, in the case of consumer electronics devices, such as mobile phones, most products are relatively comparable in the technical ability of the phone within certain product price ranges. That is, there is little from the functional feature set of the product to distinguish one manufacturer's products from another. Thus, for manufacturers and retailers, products are differentiated by the degree of detail and/or customization that a product provider and/or customer has in the design of the product or in the post purchase decoration of the product, and these entities will have a commercial advantage in view of the growing trend and desire for component providers and consumers to want to detail or personalize consumer products to distinguish them from others in the marketplace and/or to “make them their own”. Those that are able to provide flexibility in the detailing and customization of the product to accommodate certain moods, emotions, thoughts or feelings, or to accommodate certain environmental circumstances and/or situations, will have an even better commercial advantage.

Methods and systems according to several embodiments allow product providers and/or customers to apply imagery to the product or device, a portion of the device and/or an accessory to the device to achieve a form of detailing and/or customization that is not currently available in the marketplace. Due to the flexibility this provides the product provider and/or customer, the product provider and/or customer can take advantage of current trends or events without the need to forecast the consumer popularity of the trend or event within the normal manufacturing design cycle. In some embodiments, the devices, parts thereof or accessories therefor may be detailed/customized for use by consumers, retailers, distributors and other commercial and non-commercial entities, and/or governmental entities such as local, regional and/or national entities.

In one example, a customized design is applied (e.g., printed or painted) onto at least a portion of an at least partially light transmissive substrate which is applied as a screen protecting cover or skin over at least a portion of an exterior surface of a mobile phone (or other device having a display screen) either via static cling or adhesive. At least a portion of the screen protecting skin is free of any design or decoration to form a window and positioned about at least a portion of the display screen of the mobile phone so that once applied to the phone, the cover does not block the user's view of the screen or ability to read data that appears on the screen, but protects the screen with the window portion of the cover that is positioned over the screen. In some embodiments, the cover is designed as a thin and flexible film or other suitable material so that it does not interfere with the user's ability to interact with the user interface of the phone such as by using finger or thumb gestures or movements to actuate, operate or interact with a capacitive touch sensitive screen interface on the mobile phone. The integral design of a decorative cover (or skin) and a screen protecting cover (or skin) allows the cover to be applied to the mobile phone without creating air gaps between the portion of the cover that functions as the window or screen protector and the portion of the cover that covers additional portions of the mobile phone with the customized or decorated design element/s.

In another example, a black border or black masking (other colors are contemplated) is printed or painted on a PSA film and removably or permanently adhered to what will eventually be an unexposed surface (also referred to as a through surface or second surface) of a light transmissive structure, such as glass, that is later connected to a consumer product (e.g., a smart phone, tablet computer, etc.). The border PSA is used to define a viewable window for a multi-touch capacitive touch screen used in the consumer product and covers-up the screen connections so that the consumer product looks cleaner and more finished. Some examples of such a PSA border are disclosed in U.S. Provisional Patent Application No. 61/554,473, filed Nov. 1, 2011 by Hegemier et al. and entitled “METHOD AND APPARATUS FOR CUSTOMIZING CONSUMER PRODUCTS WITH IMAGES APPLIED TO SECOND SURFACES OF LIGHT TRANSMISSIVE STRUCTURES”, which is incorporated herein by reference in its entirety. An advantage of some embodiments of this configuration is that if an error occurs in the border applying or masking step of the consumer product assembly process, the PSA film can simply be removed and either reapplied correctly or removed and replaced with an alternate border PSA film without the need to discard the entire light transmissive panel and incur the expense associated with such waste. Another advantage of some embodiments is that the design of the PSA is protected by the light transmissive panel from external forces that the exterior of the panel and/or consumer product will undoubtedly be exposed to during the product's lifetime (e.g., wear and tear from pulling a phone in and out of its case or a user's pocket, droppage, exposure to environmental elements, repeated finger and thumb movements to actuate the capacitive touch screen, etc.).

In another form, a two dimensional (2D) and/or three dimensional (3D) image or images is/are applied to an at least partially light transmissive substrate, such as a PSA or static cling skin, and connected to either an exposed or unexposed surface of a light transmissive structure that makes-up the display cover (or “A cover”) of a laptop or a portion of such cover, similar to that disclosed in co-pending U.S. Provisional Patent Application No. 61/495,374 filed Jun. 9, 2011 by Hegemier et al and entitled “METHOD AND APPARATUS FOR PERSONALIZING CONSUMER PRODUCTS”, which is incorporated herein by reference in its entirety. This 2D and/or 3D image or design may be designed by the producer of the product and include, for example, the producer's trademark or distinctive trade dress or, in alternate business models, may be designed by end consumers that are customizing the manufacture of their computer (e.g., consumers who are selecting product features and components in a made-to-order computer business model). As mentioned above, a benefit to this configuration is the ability to protect the design of the PSA and the ability to detail and/or customize the consumer product.

In yet another form but somewhat related to the last, the design structure may be printed and/or painted with design elements on opposite sides of the at least partially light transmissive structure or skin. This may be done so that the skin can be flipped to swap between the alternate designs or may be done to create a more three dimensional (3D) looking image by using the image on the backside of the skin to give the image more depth or the illusion of depth. For example, in one form the screen protecting skin may have identical designs on opposite sides thereof so that as one side starts to fade or wear away due to exposure and/or daily wear and tear, the skin can be flipped to use the non-faded or non-worn version of the image. In this way, the useful life or shelf life of the skin may be lengthened (e.g., doubled or even lengthened further) and/or the skin may provide the user with an easy fix for situations wherein the image on one side of the skin has inadvertently or accidentally be damages (e.g., marred, smudged, scratched, etc.).

In yet another form, the skin may have different designs on opposite sides of the skin so that the user can swap between two images to display on the consumer product. For example, one image may be more professional looking in appearance and the other more casual or personal in appearance, thereby, allowing the user to display the more professional looking image during periods of the day when the user is at work or with clients or the like and the more casual or personal image when the user is at home or with friends. Similar flippable customization concepts and substrates are disclosed in co-pending U.S. provisional patent application No. 61/553,847, filed Oct. 31, 2011 by Hegemier et al. and entitled “METHOD AND APPARATUS FOR PERSONALIZING CONSUMER PRODUCTS”, which is incorporated herein by reference in its entirety.

This incorporated application provides further disclosure on how imagery can be applied to opposite sides of the substrate and further information on the various ways in which images can be formed and applied to substrates can be found in U.S. patent application Ser. Nos. 11/726,960, filed Mar. 23, 2007 by Hegemier et al. and entitled ADHESIVE COVER FOR CONSUMER DEVICES, now U.S. Pat. No. 8,110,268 issued Feb. 7, 2012, 11/759,600 filed Jun. 7, 2007 by Hegemier et al. and entitled FISHING LURES AND ADHESIVE COVERS FOR SAME, now U.S. Pat. No. 6,021,732 issued Sep. 20, 2011, 61/332,745 filed May 7, 2010 by Hegemier et al. and entitled SYSTEMS AND METHODS OF ON DEMAND MANUFACTURING OF CUSTOMIZED PRODUCTS, 13/103,997 filed May 9, 2011 by Hegemier et al. and entitled SYSTEMS AND METHODS OF ON DEMAND MANUFACTURING OF CUSTOMIZED PRODUCTS, which are incorporated herein by reference in their entirety. Additional ways in which the flippable screen protecting skin or substrate may be connected to the consumer product, such as by way of a bumper, are illustrated in U.S. provisional patent application No. 61/565,458 filed Nov. 30, 2011 by Hegemier et al. and entitled METHOD AND APPARATUS FOR PERSONALIZING CONSUMER PRODUCTS which is also incorporated herein by reference.

In some forms, such a skin may be configured to allow a user to move the skin between two positions on a consumer product. For example, in one form the skin may be moved from a position wherein it is protecting at least a portion of the screen or display of a laptop to an alternate position, such as the A cover of the laptop. In yet other forms, the skin may wrap around the consumer product to cover more than one surface of the product if desired. For example, the screen protecting skin may cover the screen of a laptop and wrap around the sides of the laptop cover or even wrap further around the laptop to cover the sides and at least a portion of the back side of the cover of the laptop.

Thus, it should be understood that embodiments of the invention disclosed herein may be implemented in a variety of different ways, embodiments and applications as illustrated herein and in the references incorporated herein. For convenience, some exemplary embodiments will now be discussed in more detail.

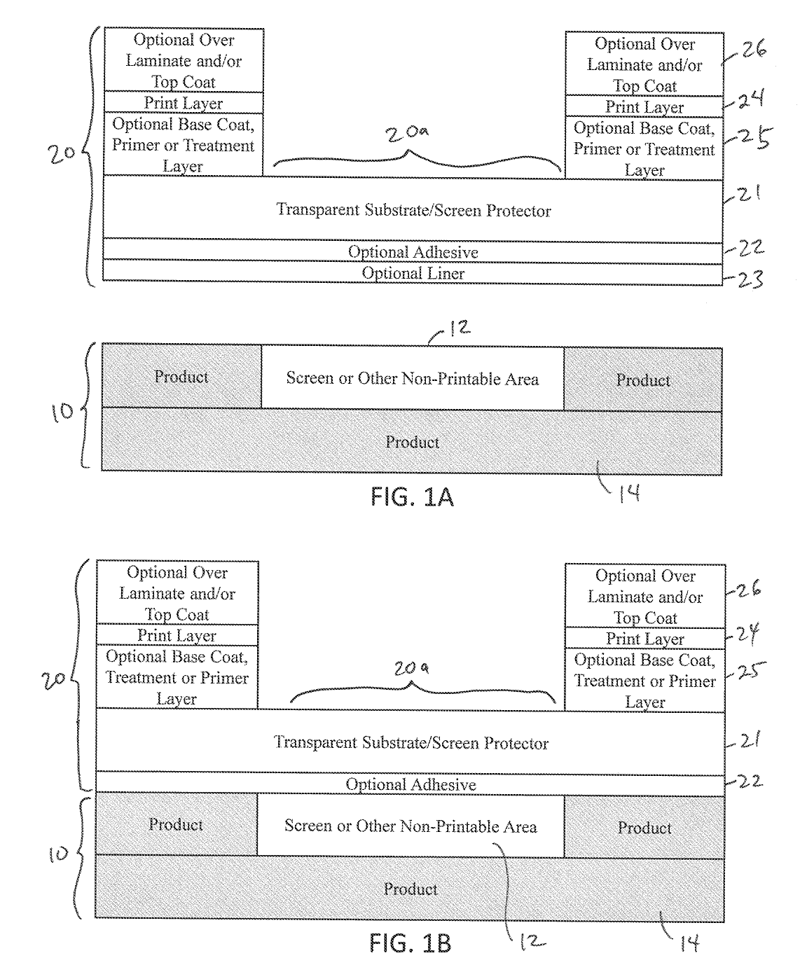

Referring to FIGS. 1A-1B, layering diagrams are shown of imagery applied to an integral screen protector and decorative film cover 20 to be applied to and protect a surface of a consumer product 10 having a display screen. The cover 20 may also be referred to as a skin, a film, a sheet, etc. that functions to protect the display screen or other viewable area of the product and provide decoration to another portion of the product. The cover 20 includes an at least partially light transmissive substrate 21 or carrier having first and second opposite sides. In the form illustrated, the consumer product 10 includes a display screen or display area 12 and a body, such as a housing 14.

On one side of the substrate 21 is an optional adhesive layer 22, such as pressure sensitive adhesive (PSA) and a liner 23 which can be used to adhere the cover 20 to the consumer product 10. It should be understood, however, that in alternate embodiment, the cover 20 may be applied to the consumer product 10 via static electricity depending on the material of the substrate 21. On the opposite side of the substrate 21 is an image layer, such as print layer 24, which contains a desired image or design to customize or decorate the cover 20 and ultimately the consumer product to which it is attached. It should be understood that in alternate embodiments the image layer may be a paint layer, combination of print and paint layers or the like. During the application of the print layer 24, the substrate 21 may first be treated with an optional base coat or primer layer 25 to assist in the printing or painting of the image layer and/or may include an optional over laminate or top coat layer 26 applied over the print layer 24 to protect the print layer 24 and/or obtain the desired finish or look (e.g., gloss, semi-gloss, flat, etc.).

As illustrated in FIG. 1B, the cover 20 and the consumer product 10 are connected to one another by removing the liner 23 and adhering the integral screen protector and decorative cover 20 to the consumer product 10 via the adhesive 22. In the form illustrated, at least a portion of cover 20 is left free of imagery about at least a portion of the display screen 12 of the consumer product 10 to form a window portion 20a through which the user may view the display screen 12 or other area of the product 10 that is intended to be viewed by the consumer once the cover 20 has been applied thereto. In the form illustrated, the window portion 20a of the transparent substrate 21 left free of imagery aligns substantially exactly with the size of the display screen 12; however, as will be discussed in further embodiments below, in alternate forms, this may not be the case and the window portion 20a may be larger than or smaller than the size of the display screen 12 to which the cover 20 is applied.

Once applied to the consumer product 10, the cover 20 provides a uniform protective coating over at least a portion of a surface of the product 10 including both the screen 12 and at least a portion of the surrounding housing portion 14 (which may be an entire surface of the consumer product 10, a portion of a surface of the consumer product 10, or multiple surfaces of the consumer product 10). This protective coating does not have gaps between the window portion 20a and the remainder of the cover 20 and, thus, portions of the screen 12 will not be exposed due to misalignment of the cover 20 nor will spaces be created into which dust, dirt or other particles may fall and collect to negatively impact the appearance of the consumer product 10 and cover 20. In addition, the window portion 20a will not cause air gaps or bubbles due to overlapping with a separate film/skin structure due to the integral nature of the window portion 20a and the remaining portion of the cover 20.

It is noted that in some embodiments, the substrate 21 is substantially transparent so as to allow portions of the product to be viewable through non-decorated portions of the substrate 21. In other embodiments, the substrate is partially light transmissive, e.g., translucent, to allow portions of the product to be at least partially viewable through non-decorated portions of the substrate 21. In some embodiments, the image layer (e.g., print layer 24) is wholly or partially light transmissive to block view of certain portions of the product or to allow certain portions of the product to be partially viewable through the image layer.

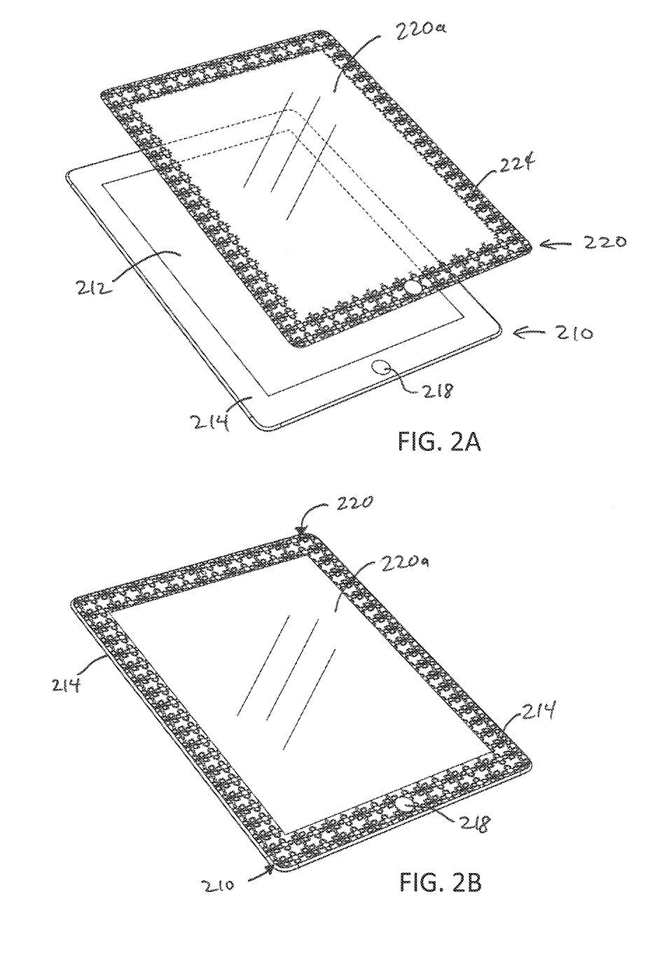

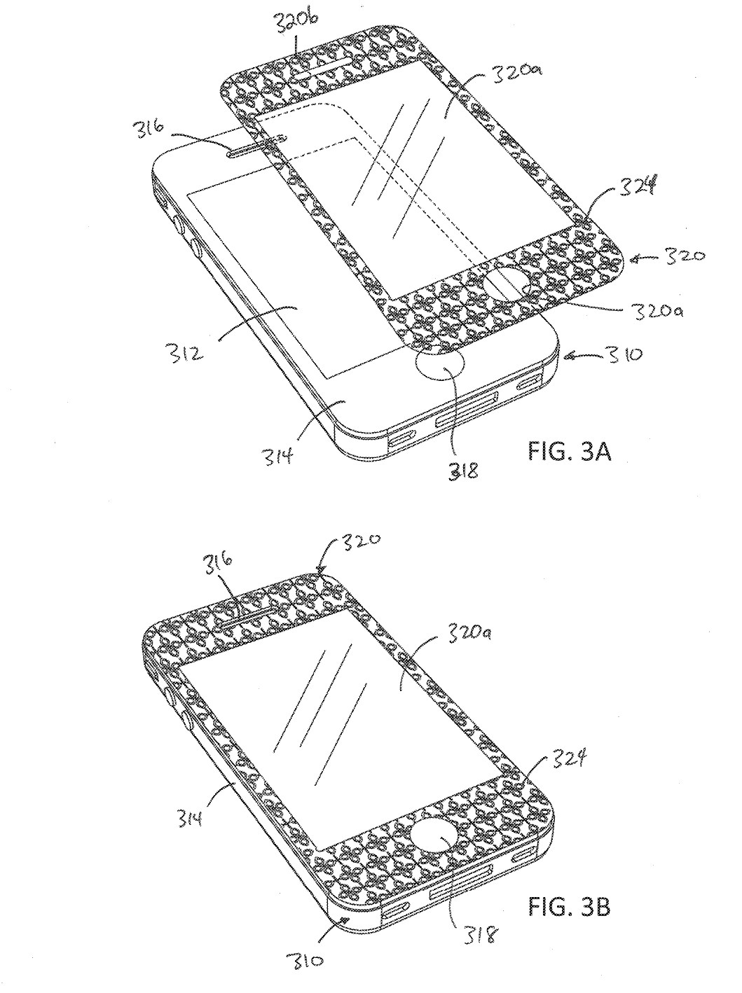

Referring next to FIGS. 2A-3B, embodiments of such integral protector and decorative covers and exemplary consumer products are illustrated. For convenience, items that are similar to those discussed above with respect to FIGS. 1A-1B will use the same two-digit reference numeral, but beginning with prefix “2” for the embodiment of FIGS. 2A-2B and the prefix “3” for the embodiment of FIGS. 3A-3B. In FIGS. 2A-2B, the cover 220 is illustrated exploded from and connected to the consumer product 210, respectively. In this form, the consumer product 210 is an APPLE IPAD brand tablet computer. The window portion 220a of the cover that is free of imagery 220a is aligned with the capacitive touch screen display screen 212 of the product 210 so that the cover 220 can protect the display screen 212 without interfering with the user's ability to view the display screen 212 and actuate or interact with the capacitive touch screen 212. In a preferred form, the cover 220 further includes openings, such as cutouts or bores 220c for input button 218 of product 210.

In FIGS. 3A-3B, the consumer product 310 is a smart phone such as the APPLE IPHONE brand smart phone. The window portion 320a of the cover 320 that is free of imagery is aligned with the capacitive touch screen 312 of the product 310 so that the cover 320 can protect the display screen 312 without interfering with the user's ability to view the display screen 312 and actuate or interact with the display screen 312 using the capacitive touch capabilities of same. In a preferred form, the cover 320 further includes openings, such as cutouts or bores 320b and 320c for the speaker 316 and input button 318, respectively, of the product 310.

In alternate forms, the cover 320 may cover more or less of the consumer product 310 as desired. For example, in some forms, the cover 320 may only cover a portion of the surface having the screen 312. In other forms, the cover 320 may cover a portion of the screen 312 and a portion of the surrounding consumer product body 314. In still other forms, the cover 320 may wrap around the sides of the consumer product 310 to cover additional surfaces thereof. In such embodiments, however, it is desirable to have additional openings or bores for other consumer product features such as, for example, input buttons (e.g., volume, silent mode/mute, power on/off, etc.), microphone openings, power jack openings, headphone jack openings, interface ports (e.g., USB ports, fire wire ports, SIM card slots, etc.) and the like.

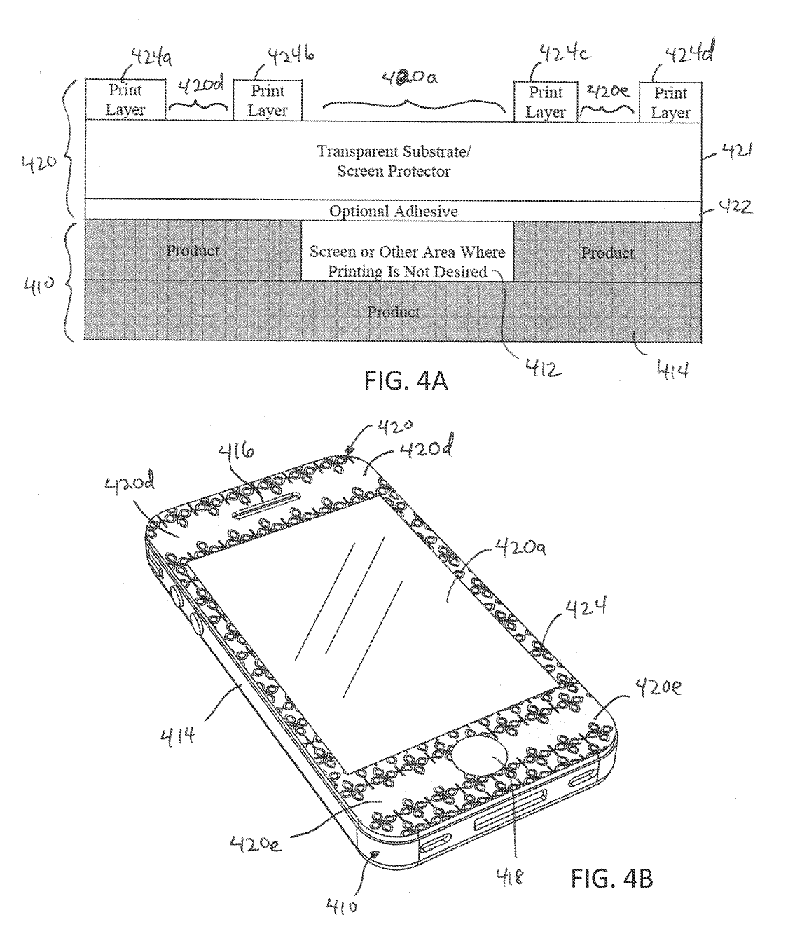

In FIGS. 4A-4B, an alternate form of an integral protector and decorative film cover is illustrated having image layers that cover multiple portions of the consumer product, but also having gaps or additional spaces wherein no imagery is present so that at least some other portions of the consumer product housing is visible in those areas. In keeping with the above practice, items in this embodiment which are similar to those discussed above will use the same two digit reference numeral but use the prefix “4” in order to distinguish one embodiment from the others. In the form illustrated, the cover 420 is a PSA skin like covers 20, 220 and 320 discussed above connected to consumer product 410. The consumer product 420 has a surface having a display or screen 412 (or other area intended to be viewed by the consumer) and surrounding body or surface 414. The cover 420 has an at least partially light transmissive layer or substrate 421, such as a transparent carrier, that is connected on one side to the consumer product 410 via adhesive layer 422. An image layer made up of a plurality of image elements 424a, 424b, 424c and 424d is applied to the side of the substrate 421 opposite the side containing the adhesive layer 422. As illustrated, the image has gaps or spaces 420d and 420e wherein no imagery is present and the surface of the consumer product 410 is visible through the substrate 421, just like the window portion 420a which provides a window through to the screen 412. Thus, it should be understood that the imagery of the cover 420 make take on any appearance including some that at least partially block the view of the consumer product below in some places, some that only partially obstruct the view of the consumer product below in places, and some that do not obstruct the view of the consumer product below.

FIG. 4B is a perspective view of an exemplary consumer product 410 and cover 420. In this form, the consumer product 410 is a smart phone and the cover 420 has a window portion 420a through which the screen 412 may be viewed, as well as, spaces or gaps 420d, 420e wherein no imagery obstructs the view of the consumer product below the skin in those locations. This may be desired in order to provide some areas where it is desirable to show the consumer product below the skin. Alternatively, this may simply be a byproduct of the design selected for the cover 420. It should be understood that this is one example of such a cover and that numerous other examples of film or skin covers can be created in accordance with this embodiment. As mentioned above, it should also be understood that the cover 420 could cover additional surfaces of the consumer product and include additional openings or bores to ensure that the cover 420 does not interfere with the functional performance of the consumer product 410, such as the openings for speaker 416 and input button 418.

In FIGS. 1A-4B, the image layer (e.g., print layers 24, 224, 324 and 424) is shown applied to the first side of the cover 20, 220, 320 and 420, which is the outer or exposed side of the cover substrate. As mentioned above, in alternate embodiments, the image layer may be applied to a second surface or backside or through surface of the cover substrate for through surface imaging. Advantages to such second surface imaging are disclosed in U.S. Provisional Patent Application No. 61/554,473 filed Nov. 11, 2011, which has already been incorporated herein by reference above. Some brief examples of such advantages are that backside imaging provides additional protection for the image and keeps the first side of the substrate free of imaging so that it is easier to clean without disrupting the image. More particularly, by imaging the backside of the substrate, the image is not exposed to the external environment and is thus protected from forms of contact that might otherwise soil (e.g., smudge, mar, etc.) or damage (e.g., scratch, crack, etc.) the image. In addition, by having the image located below the surface of the substrate, the exterior surface of the substrate can be cleaned without worrying about damaging the image.

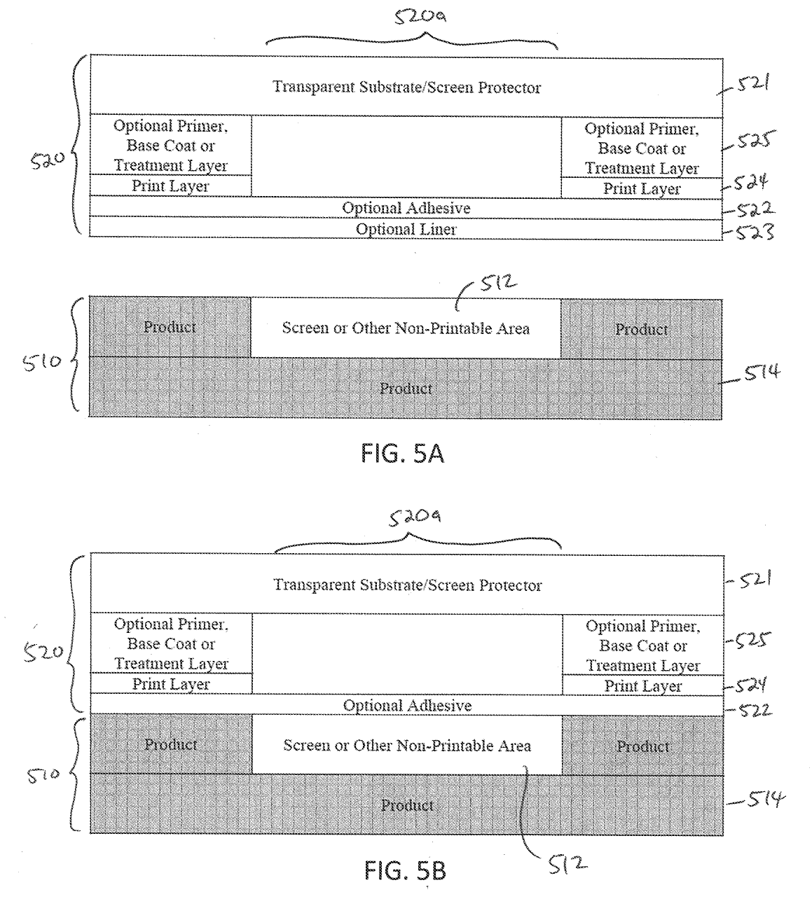

Referring next to FIGS. 5A-5B, layering diagrams are illustrated for a second surface imaged substrate showing the cover exploded from the consumer product and connected to the consumer product, respectively. In keeping with the above practices, items which are similar to those discussed above will use the same two digit reference numeral with the prefix “5” to distinguish one embodiment from another. In the form illustrated, the substrate 521 is an at least partially light transmissive substrate or carrier, such as a transparent substrate, with a first and second side. Print layer 524 (an example of an image layer) is connected or applied to the second side of the substrate 521. The second side of substrate 521 may also be treated with an optional primer or base coat layer 525 prior to the application of the print layer 524 in order to improve the quality of the print layer 524. In the form illustrated, the liner 523 is removed from cover 520 and the cover is connected to the product 510 via an adhesive layer 522 (such as a pressure sensitive adhesive) to form the combined protector and decorative cover and consumer product illustrated in FIG. 5B.

Although the embodiment illustrated in FIGS. 5A-5B does not include an optional over laminate or top coat layer like that illustrated in FIGS. 1A-1B, it should be understood that in alternate forms, such over laminate and top coats may be applied if desired. Furthermore, in alternate forms, the cover 520 may be connected to the consumer product 510 via other means, such as electrostatically, rather than adhesive. In yet other forms, the cover 520 may be connected to the consumer product 510 via mechanical or other means, such as the friction fittings or bumpers discussed in the references incorporated herein.

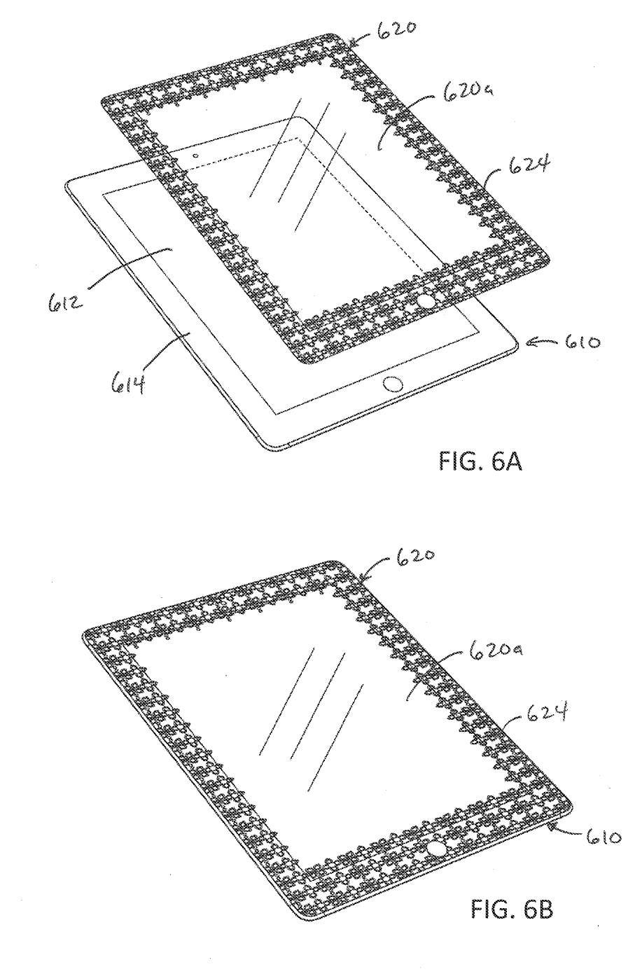

Referring next to FIGS. 6A-6B, perspective views are shown of an exemplary integral protecting and decorative cover according to some embodiments and exploded from and connected to an exemplary consumer product, respectively. In this form, items which are similar to those discussed above use the same two digit reference numeral in combination with the prefix “6” in order to distinguish one embodiment from another. In the form illustrated, the consumer product 610 is a tablet computer and the cover 620 has a window portion 620a that is slightly smaller in size than the area of the screen 612 of the consumer product 610. Thus, in this configuration, a portion of the image layer 624 actually covers a portion of the substrate covering a portion of the screen 612 and allows the design depicted by the image layer 624 to define a desired visible screen size for the consumer and/or a unique or decorative frame for the screen 612. Such a design may be desired for aesthetic purposes or functional purposes. For example, in some forms such a design may be desired because a screen of smaller size is preferred over that provided with the consumer product. In another form, such a design may be desired to hide icons or other items that appear in a certain locations on the screen.

Although the portion of the image layer 624 that covers a portion of the screen 612 in FIGS. 6A-6B merely frames the screen 612, it should be understood that in alternate embodiments, the image layer 624 may be designed to place imagery elsewhere on the screen or window portion covering the screen.

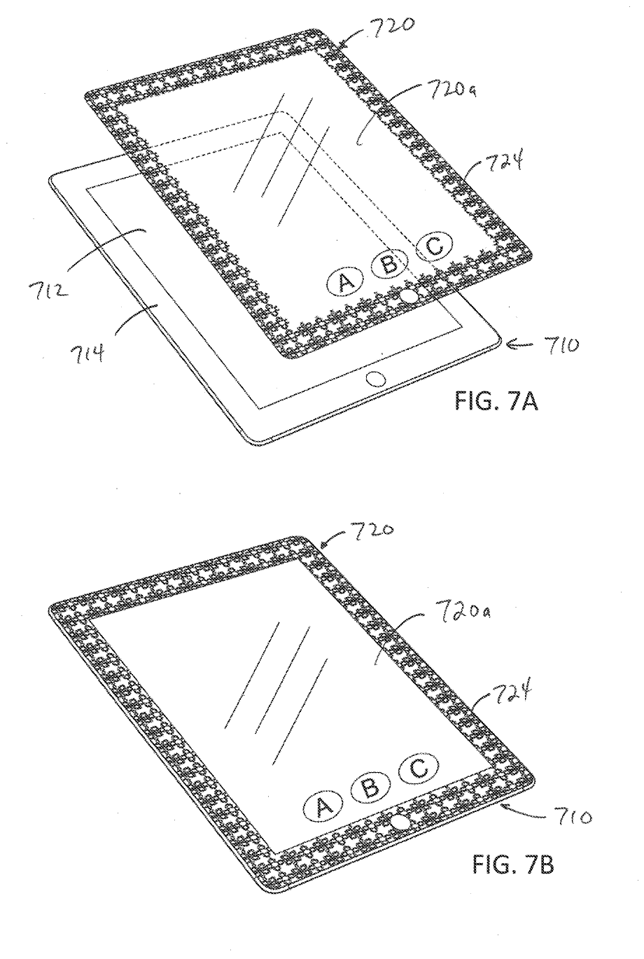

Referring next to FIGS. 7A-7B, items which are similar to those discussed above utilize the same two digit reference numerals but with the prefix “7” to differentiate this embodiment from prior embodiments. In the form illustrated, the image layer 724 not only defines a frame for the screen 712, but also includes permanent input indicia A, B and C (e.g., functional design or decorative elements), which can be used by the consumer or user to help identify areas of the screen 712 to be pressed in order to make a desired selection. For example, in one form the product 710 may be used to perform routine tasks where the user is required to select from options A, B or C (e.g., a given app run by the tablet computer may require user interaction defined at the screen locations of the indicia A, B or C). Thus, with this configuration the application being run by the product 710 can be designed without touch screen input buttons, and can rely on the inputs A, B and C delineated by the cover 720 itself thereby allowing the application to focus on other items such as providing a better picture more details about a particular item.

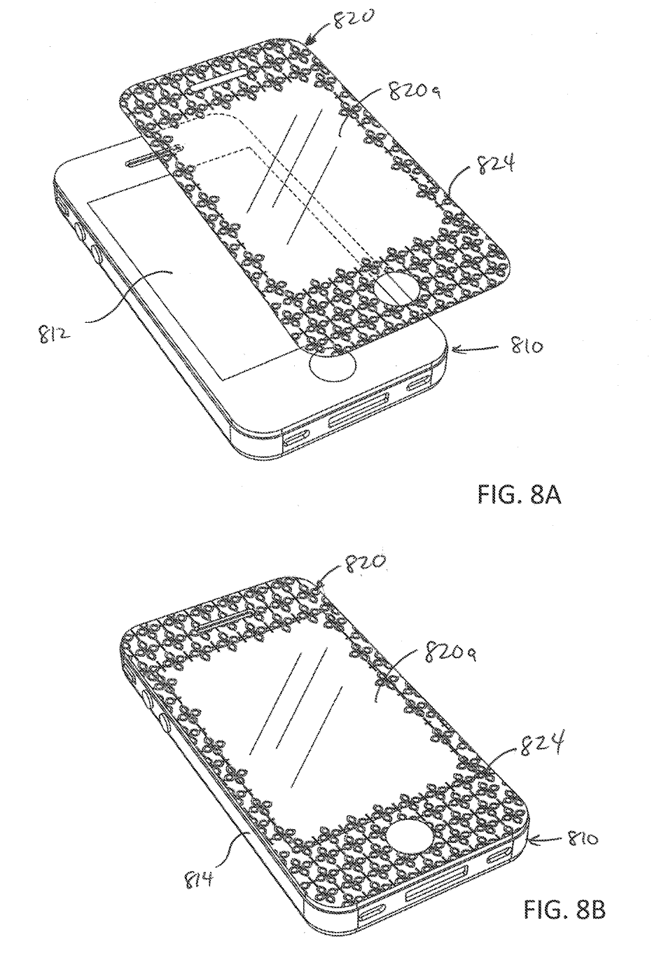

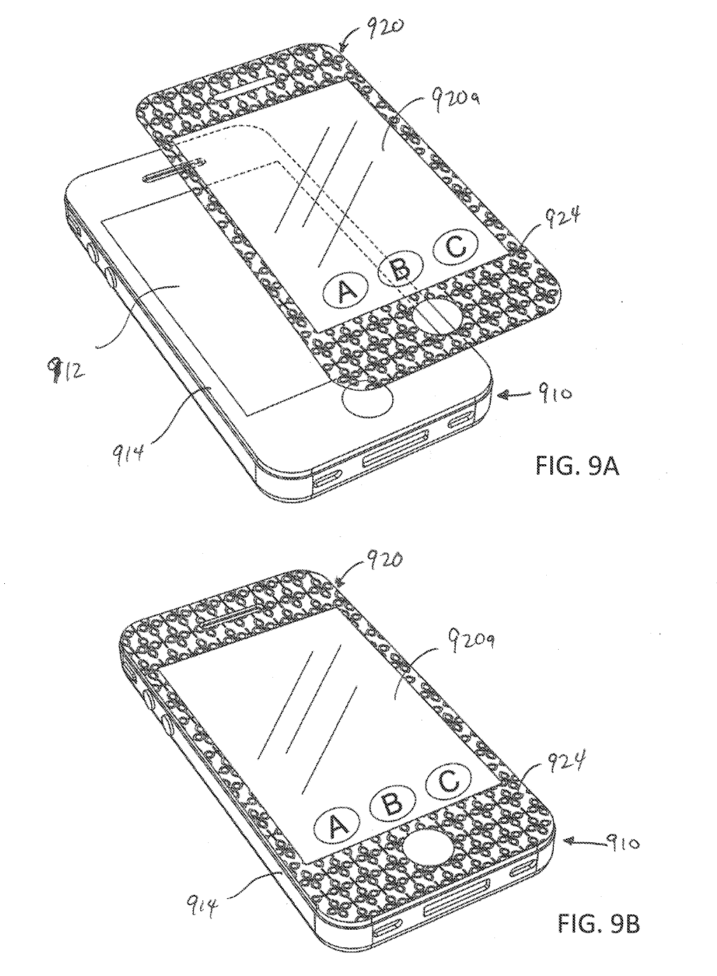

Although FIGS. 6A-7B depict a tablet computer as an exemplary product, it should be understood that in alternate forms the consumer product may take any shape or size. For example, in FIGS. 8A-8B and 9A-9B, similar embodiments are illustrated, however, in these forms the consumer products are smart phones rather than tablet computers. More particularly, FIGS. 8A-8B illustrate perspective views of a cover 820 that covers at least part of the screen 812 of the consumer product 800 to frame the screen 812 of the consumer product and/or cover certain portions of the applications running on the smart phone. In keeping with the above practice, elements which are similar to those discussed above with respect to other embodiments use the same two digit reference numeral but include prefix “8” in order to distinguish one embodiment from another.

Similarly, in FIGS. 9A-9B, the product 900 (i.e., a smart phone) is illustrated with a cover 920 that not only defines a frame for the screen 912 of the consumer product 900 but also includes inputs A, B, C which can be used to assist the product user in performing routine tasks on the smart phone. In these figures, items which are similar to those discussed above utilize the same two digit reference numerals but include the prefix “9” to distinguish one embodiment from another. Thus, with this configuration the application being run by the smart phone 910 can be designed without touch screen input buttons, and can rely on the inputs A, B and C delineated by the cover 920 itself thereby allowing the application to focus on other items such as providing better or more complete pictures, more details, etc.

The ability to apply imagery on the cover substrates discussed above also makes it possible to use the cover to create designs that not only cover at least a portion of the body portion of the consumer product, but also cover portions of a display, display screen or other area intended to be viewed by the consumer. This increases the types of designs or customization that may be placed on the consumer product and allows for new areas of design to be pursued.

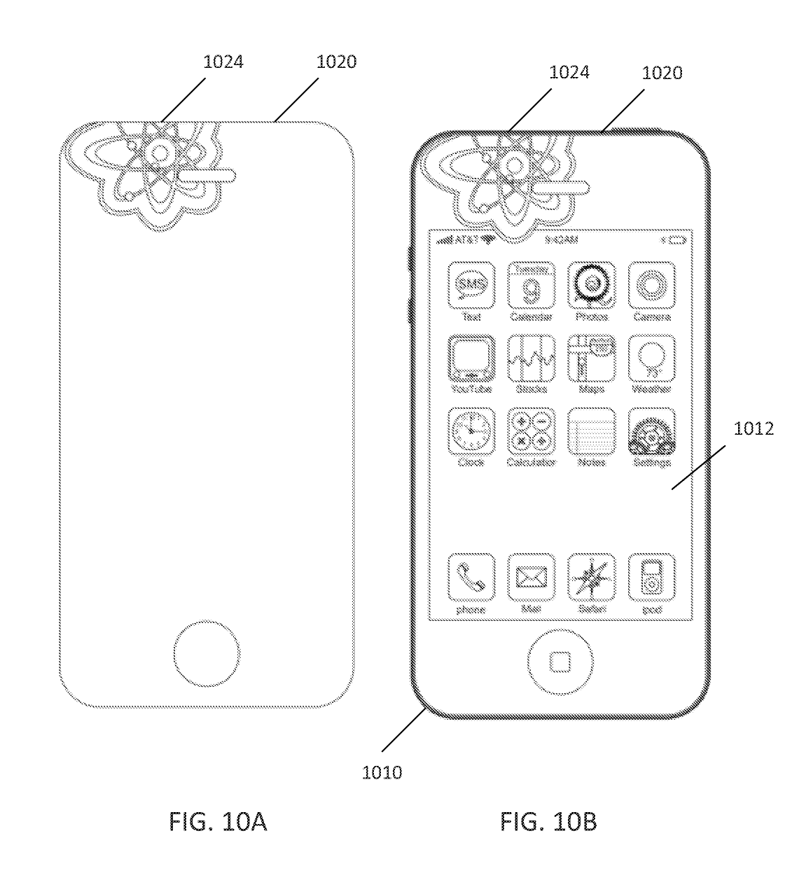

Referring next to FIGS. 10A-10B, views are shown of an integral screen protector and decorative film cover in accordance with another embodiment, the cover illustrated by itself in FIG. 10A and as applied to an exemplary consumer product 1010 in FIG. 10B. In this illustration, common items will be identified using the same two-digit reference numeral in combination with the prefix “10”. In the form illustrated, the image layer 1024 of cover 1020 includes an “atom” illustration that covers both a portion of the consumer product body as well as a portion of the screen 1012, i.e., the image layer is applied to a portion of the window portion of the cover 1020. In some forms, the image used may relate to a corporate trademark, trade dress or logo, a person's initials, insignia or family crest, etc. It is noted that in this embodiment, the image layer does not cover all of the portion of the cover other than the window portion of the cover, i.e., it only covers an upper portion of the cover.

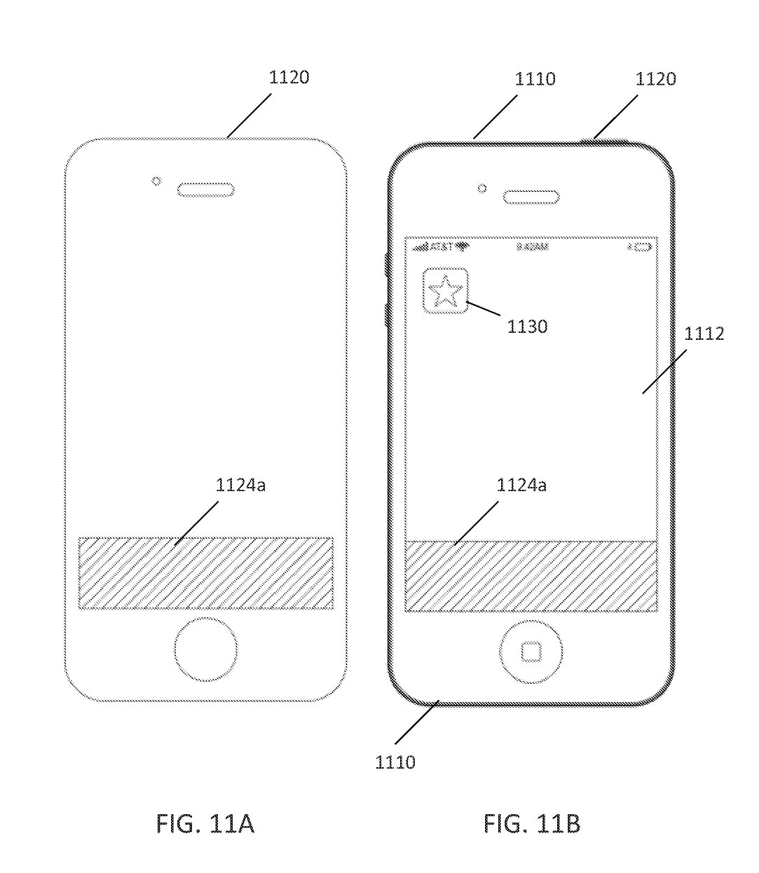

As mentioned above, this ability to apply imagery to screen portions of skins also allows the skin to be used to alter the functionality of the consumer product. For example, in FIGS. 11A-11B, views of an integral screen protector and decorative film cover in accordance with another embodiment, the cover illustrated by itself in FIG. 11A and as applied to an exemplary consumer product 1110 in FIG. 11B. Items similar to those discussed above use common two digit reference numerals in combination with the prefix “11”. In the form illustrated, the image layer 1124 of cover 1120 includes a blacked-out portion 1124a (opaque portion) that visually blocks the lower row of applications that would normally be visible at the bottom of screen 1112. In one example, this may emphasize the desired application 1130 that is intended to be used by the user. For example, in one form consumer products such as the smart phone illustrated in FIG. 11B may be handed out to employees to perform a specific task. In order to limit the employees' use of the smart phone, the cover 1120 is designed with an image that blacks out the lower row of applications on the smart phone, such as internet browser applications, texting applications, emailing applications and the like, so that the smart phone can only be used for the desired purpose, e.g., by using the application 1130. In some forms, the material used to print or paint the blackout image on the cover 1120 may include material that blocks the capacitive touch screen's ability to detect fingers or thumbs placed in the blacked-out region. Thus, the cover 1120 may not only place the hidden items out of sight and out of mind, but may further prevent actuation of the applications via the image layer applied to the skin that interferes with the user's ability to interact with the touch screen. Further, the application 1130 when executed may be designed knowing that it will be used in cooperation with the cover 1120 and the blacked-out portion 1124a. For example, in use, the application 1130 is configured to not use the portion of the display covered by the blacked-out portion 1124a, e.g., the application 1130 will not display graphics or imagery, backgrounds, etc., for the portion of the display screen covered by portion 1124a.

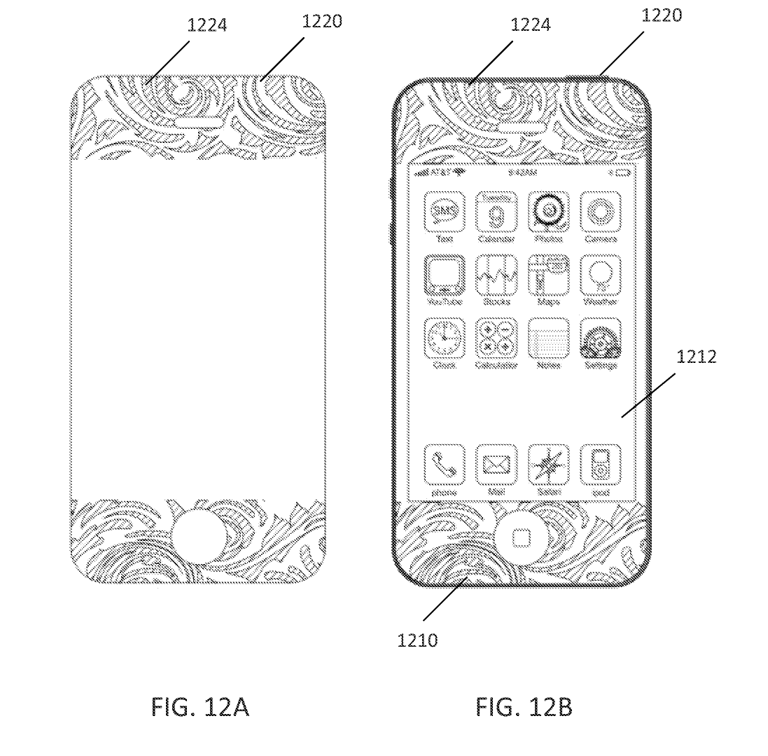

Referring next to FIGS. 12A-12B, views are shown of an integral screen protector and decorative film cover in accordance with another embodiment, the cover illustrated by itself in FIG. 12A and as applied to an exemplary consumer product in FIG. 12A. Items similar to those discussed above use common two digit reference numerals in combination with the prefix “12”. In this embodiment, the image layer 1224 do not cover the window portion of the cover 1220 and it selectively covers a remaining portion of the cover, such that the display screen 1212 is viewable through the window portion and some of the remaining portions of the product 1210 are viewable through the cover 1220. Again, the cover 1220 functions to protect a surface of the product 1220 having a display screen (or other area intended to be viewed by the consumer) and decorate at least a portion of the product 1220. It is also noted that the image layer 1224 selectively covers the portions of the cover above and below the window portion, and does not cover the window portion of the areas to the left and right of the window portion. It is understood that in other embodiments, the image layer may cover at least a portion of the areas the left and right of the window portion, or cover at least a portion of the window portion itself. It is noted that the image layer 1224 covers some portions of the non-window portion of the cover 1220 and does not cover some portions of the non-window portion of the cover in order to enhance the appearance of the consumer product (e.g., some portions above and below the window portion do not have an image layer). As such, even areas of the cover 1220 that do not include an image layer cooperate with areas of the cover 1220 that do have an image layer to enhance the appearance of the consumer product.

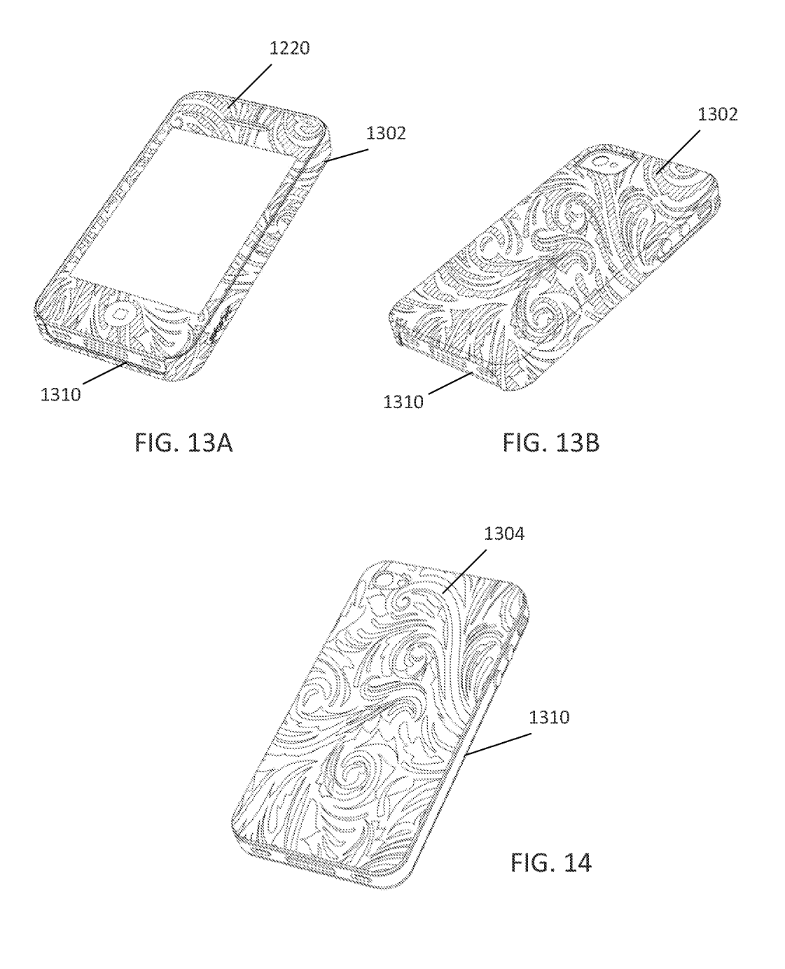

Referring next to FIGS. 13A-13B, front and back perspective views of an integral screen protector and decorative film cover 1220 having a design and/or imagery that cooperates imagery on a corresponding case 1302 for an exemplary consumer product 1310 according to some embodiments. The imagery applied to the case may be printed or painted or applied in any manner described herein. In some embodiments, the image layers of the cover 1220 and the case 1302 are configured to appear to flow seamlessly from one component to the other, or otherwise cooperate with each other, or otherwise compliment each other. It is understand that the case 1302 may optionally be another accessory for the product 1310 in some embodiments. In other embodiments, the cooperating imagery may be applied directly to a panel, wall, door or other structure that is part of the product 1310 itself, rather than a case or accessory for the product 1310.

Referring next to FIG. 14, a back side perspective view is shown of an exemplary consumer product 1310 having a decorative film cover 1304 applied to a back surface of the product, the film cover having a design and/or imagery that cooperates imagery on a corresponding integral screen protector and decorative film cover for the consumer product such as shown in FIGS. 12A and 12B according to some embodiments. The film cover 1304 may be an adhesive backed film or skin or other electrostatically held film or cover, such as those described herein. In some embodiments, the image layers of the cover 1220 and the film cover 1304 are configured to appear to flow from one to the other, or otherwise cooperate with each other, or otherwise compliment each other.

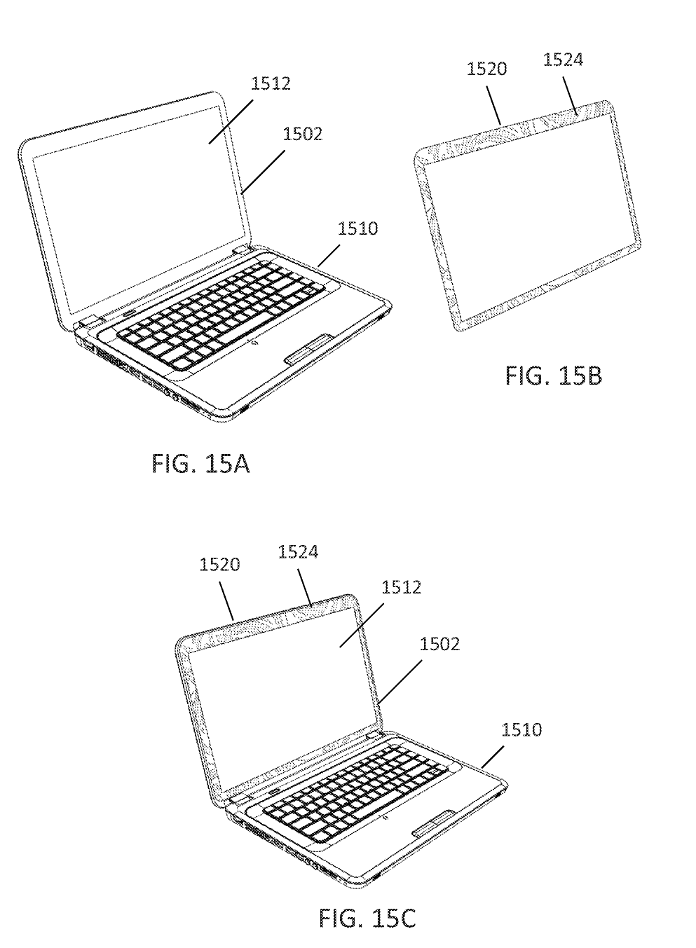

Next referring to FIGS. 15A-15C, perspective views are shown of a notebook style computer product 1510 having a display screen 1512 (FIG. 15A), a corresponding integral screen protector and decorative film cover 1520 separated from (FIG. 15B) and coupled to (FIG. 15C) the computer product 1510, in accordance with some embodiments. The display screen 1512 may be surrounded by a frame 1502 or bezel (often referred to as a “B cover” for notebook style computers) that acts as a border and frames the display screen 1512. The surface of the display screen 1512 may be inset within the frame 1502 or may be flush with the surface of the frame 1502. In some cases, the surface of the display screen 1512 extends to the edge of the lid body such that the display screen surface covers the display screen and the frame 1502. The cover 1520 is applied to cover and protect the display screen 1512 and the frame 1502. The cover 1512 includes an image layer 1524 that is applied (according to any of the techniques described herein) thereto (e.g., either to the front or through surface of the substrate of the cover). In the illustrated embodiment, the image layer is applied to the edges of the cover 1520 to cover the frame 1502 but not obscure the user's view of the display screen 1512. In this way, the cover 1520 functions to protect the display screen but and decorates or enhances the appearance of the frame, and thus, the consumer product. In other embodiments, the image layer covers at least a portion of the window portion (e.g., the portion covering the display screen) of the cover 1520 such as other embodiments described herein. In other embodiments, the image layer 1524 covers all or less than all of the non-window portions of the cover 1520 such as other embodiments described herein. In some embodiments, the cover 1520 is a clear or tinted substrate (e.g., to reduce glare). In other embodiments, the cover 1520 has a substrate that is a traditional polycarbonate or acrylic plastic privacy filter that hinders or blocks view of the display screen at certain angles, such as those produced by 3M.

Although the above mentioned embodiments have discussed the image layer being applied to the first and second surfaces of the cover substrate for front side and backside imaging, respectively, they all have applied the cover to the first side (or exterior) of the consumer product. It should be understood that in alternate embodiments it may be desirable to apply such covers or films to the second side or backside of a portion of the consumer product. For example, some of the smart phones identified above have light transmissive housing members such as glass panels. In some forms, the above covers may be setup to be applied to the second side or backside of one or more of the light transmissive housing members. This helps protect the cover from soiling or damage that may be caused to a cover that is otherwise exposed to the external environment and/or helps make it easy to clean the consumer product by allowing the first side of the light transmissive housing member to be wiped off or cleaned without concern for the cover because of the cover's position below the light transmissive housing member (i.e., on the second side or backside of the light transmissive panel). As mentioned above, additional benefits of second surface application of the cover is disclosed in U.S. Provisional Patent Application No. 61/554,473 filed Nov. 11, 2011 which has been incorporated herein by reference.

As to the individual layers disclosed in the above-mentioned embodiments, it should be understood that the adhesive layers may be any adhesive capable of permanently or non-permanently adhering the cover to a consumer product. In one form, the PSA does not permanently attach the cover to the consumer product so that the cover can be removed from consumer product as desired. In other forms, however, the PSA may be designed with permanent or essentially permanent adhesive to prevent removal of the cover from the consumer product after application. Suitable adhesives may be obtained from a variety of suppliers known in the art. For example, in a preferred form, 3M or Avery Dennison pressure sensitive adhesives may be used.

The adhesive layers may also have a visible or non-visible pattern (not shown) formed therein that can function to channel air out from underneath the skin or film cover when applied to the consumer product. In addition, the adhesive itself may be transparent (e.g., clear), semi-transparent, opaque and or may be provided with a particular design (e.g., selected of a specific color) to either match or make-up a particular part of the overall design of the image layer.

The substrate or carrier layer may function as a foundation for the cover and can provide a desired stiffness to the cover. For example, the substrate may be rigid or flexible. In some embodiments, the substrate is flexible to allow it to be rolled for storage prior to connection to the consumer product. In some forms, the substrate may also be part of the image or design in that it may be selected for a specific color or texture that it provides to the cover. Numerous different materials and combinations of materials may be used for the substrate or base layer, including but not limited to PVC vinyl, polyolefin, or other synthetic material such as polyester, urethane, Lexan, polycarbonate, acrylic plastic, etc. Other suitable materials and combination of materials known in the art may also or alternatively be used.

In some embodiments, the image layer is applied to the substrate. For example, the image layer may be printed, painted, and/or transferred or applied using any known image application process. As mentioned above, an optional primer layer or base coat may be applied to the surface of the substrate in order to improve printability (e.g., ink absorption) or paintability of the substrate, thereby improving the quality of the image produced as the image layer. For example, if desired a corona treatment may be used to remove impurities, such as oils, and then a primer, such as Digiprime 5000 by Michelman Co., may be applied to help improve the quality of the image and/or improve the ability of the image to attach to the substrate and/or the process used to manufacture the cover. In other forms, however, no additional corona or primer step may be performed.

The image layer may also include one or more design materials, such as ink, paint or the like, for forming a design on the skin or cover and these materials may be applied in a variety of different ways, such as by digitally printing, screen printing, silk screening, painting, transferring, etc. For example, one such screen-printing technique is described in U.S. Pat. No. 6,977,023, issued Dec. 20, 2005 and entitled “Screen Printed Resin Film Appliqué or Transfer Made from Liquid Plastic Dispersion”, which is incorporated herein in its entirety. In some embodiments, the image layer comprises texture applied (e.g., painted or printed) through multiple application layers, such as described in U.S. Provisional Application No. 61/491,320, filed May 30, 2011 and entitled SYSTEMS AND METHODS FOR USE IN INLINE PRINTING, which is incorporated herein by reference. Texture in the image layer may also be used to create different visual effects in the viewing of the image layer on or through the substrate.

Additional optional layers may comprise a liquid or solid sealant, such as an overlaminate layer or top coat (not shown), which is meant to provide outside protection to at least a portion of the skin. The overlaminate layer may be painted, printed, or otherwise applied to the image layer. In some embodiments, the overlaminate layer is a solid layer applied (e.g., adhered over the image layer). In other embodiments, the overlaminate layer is a resin dome (not shown) which can be used to provide a “puffy” or three dimensional appearance to the skin. In a preferred form no such overlaminate layer or resin dome is used so that adhesive can be directly applied to the unexposed side of light transmissive substrate (which itself protects the design); however, in alternate forms, it may be desirable to apply such an overlaminate layer or resin dome to the skin or at least a part thereof. For example, in an alternate embodiment at least a portion of the design may include an overlaminate layer in order to protect portions of the design and/or enhance the visual appearance of same, etc. A calendared or cast PVC vinyl film may be applied to at least a portion of the image layer to protect same. In other forms, the overlaminate may be made of a polyolefin material or other overlaminate materials known in the art in order to avoid some of the environmental problems (e.g., disposal, regulation of, etc.) associated with PVC vinyl due to the presence of lead in some forms of PVC vinyl. In still other forms, a resin dome is applied to at least a portion of the design PVC to give the design PVC the appearance of depth and/or add dimension to the visible design thereon.

Like the adhesive layer, such overlaminate layers and/or resin domes may also include designs or design elements that work with the image layer and possibly other layers to depict a final image on the skin or cover. However, as mentioned above, in a preferred form the adhesive layer is transparent (or generally transparent) and either no overlaminate layer or resin dome is provided (or only a partial overlaminate layer and/or resin dome is provided) so that the cover can be connected directly to the underside of the light transmissive structure thereby allowing the design of image layer to be visible from the opposite side of the light transmissive structure.

Lastly, as mentioned above, in some alternate embodiments decorative pieces (not shown) may also be added to the skin or cover in order to enhance the design and/or give the design dimension. For example, a three dimensional item may be placed on the skin and then the skin is attached to the underside of glass which in turn is connected to (or rested on) a consumer product to capture the skin (including the decorative pieces) between the light transmissive substrate and the consumer product and detail/design same. Examples of some designs that may be incorporated into the skin are illustrated in co-pending U.S. Provisional Patent Application No. 61/495,374 filed Jun. 9, 2011, which has already been incorporated herein by reference in its entirety.

In some embodiments, the covers can be made in bulk and stored before being connected to the consumer product. Further, the image layers could be applied to the substrate in advance based on forecasting or may be applied on demand as demand is needed.

It should be understood that the embodiments disclosed herein may be used for a variety of different applications and with a variety of different components. For example, the skins or covers may have designs that are used to promote a business entity, group, band, individual, good or service, or may be used to allow a person to customize or individualize a particular product by either selecting a stock image or submitting their own. In some applications, the designs may be reversible or flappable as mentioned above so that a user can disassemble the product and rotate the image between two different images. For example, in one form a user may have a more business oriented image to use while at work that can be removed, rotated and reapplied to show a more personal image when not at work (or when in the mood to do so). In addition and as mentioned above, the design may be used to form a permanent portion of the device such as a screen or display border or a design, such as a solid color, for a back panel of a consumer product like a smart phone.

Thus, in applications like those disclosed in U.S. Pat. No. 7,522,236 issued to Gettemy et al. on Apr. 21, 2009 and entitled “COSMETICALLY UNIFORM REFLECTIVE BORDER AREA IN A TRANSFLECTIVE DISPLAY”, U.S. patent application Ser. No. 12/184,190 filed by Hotelling et al. on Jul. 31, 2008 and entitled “CAPACITIVE SENSOR BEHIND BLACK MASK” (now U.S. Publication No. US 2010/0026656 A1 published Feb. 4, 2010) and U.S. patent application Ser. No. 12/038,760 filed by Hotelling et al. on Feb. 27, 2008 and entitled “SINGLE-LAYER TOUCH-SENSITIVE DISPLAY” (now U.S. Publication No. US 2009/0091551 A1, published Apr. 9, 2009), which are incorporated herein by reference in their entirety, a design structure such as that disclosed herein could be used in lieu of the conventional black or opaque masking that is printed to the second surface or through surface of the glass and plastic surfaces as mentioned in these references. In addition, the layers of the design structures disclosed herein could further include conductive materials or circuits so that when these design structures are sandwiched between light transmissive structures and additional electronics of a consumer product (such as capacitive touch screens or displays) they help facilitate the operation of the component by assisting in the operation of the capacitive touch surface of the component (e.g., by helping conduct or establish the capacitance or field that is used to track movement of a user's finger or fingers over a capacitive touch screen or multi-touch screen). In other forms, thin-film transistors and/or materials such as Indium Tin Oxide can be added to the design structures disclosed herein to further enhance the performance or operation of the consumer product once such design structures are used therewith. In yet other forms, the design structures may also be provided with polarizing layers or color filtering layers in order to enhance the performance or operation of the consumer product. One advantage of all of this is that a manufacturer can keep rolls of raw materials to manufacture design structures like those discussed herein much more easily than keeping sufficient stockpiles of glass (i.e., not only stockpiles of finished second surface printed glass, but also the surplus inventory needed to account for errors in the masking and glass installing process, etc. as mentioned above). In addition, another advantage is that by utilizing conductive materials or circuits and/or polarized/color filtering films such as those mentioned above with respect to the design structures disclosed herein, can also reduce the need for expensive types of glass and allow for more affordable glass to be used and inventoried (thereby saving expense and further driving down the cost of any waste of same). Yet another advantage of some embodiments is that many consumer product applications require the use of adhesives to connect components together (see e.g., FIG. 5 in U.S. Publication No. US2009/0091551A1), thus, by being able to provide a design structure that does not only serve as border masking, but also as an adhesive, these two steps (i.e., masking and adhering) can be done with the use of one structure thereby reducing the amount of steps required in the manufacturing process and the amount of time that is required for same.

Additional layering diagrams for alternate embodiments and business methods/processes for manufacturing and selling such design structures are disclosed in U.S. patent application Ser. No. 13/103,997, filed May 9, 2011 and entitled “Systems and Methods of On-Demand Manufacturing of Customized Products”, which is hereby incorporated by reference in its entirety. As mentioned therein, the substrate may be any material, such as metal, plastic, ceramic, glass, fabric, leather, etc., or any combination thereof. Additionally, the substrate may be flat or have other dimensions or curvature depending on the consumer product involved and/or intended application.

In the event the substrate is metal or at least partially metallic, in some embodiments, a chemical film treatment layer may be applied using known chemical film treatment processes. The chemical film treatment layer may be applied in advance of an order (for example if inventory or forecasted business models are being followed) or may be done on-demand when an order is received (if on-demand business models are being followed).

In the event the substrate is plastic, a chemical film treatment layer might not be applied, and in some cases, the surface of the substrate may be plasma treated to alter or raise dyne levels to ensure good adhesion. As is known in the incorporated references herein, plasma treatment is an electrostatic process that removes oils from the surface and raises dyne levels to create attraction between molecules. In some embodiments, a primer layer or other adhesive layer may be applied as needed depending on the material of the substrate. Similarly, in the event the substrate is glass or ceramic, a chemical film treatment layer may not be applied, but an optional plasma treatment may be performed, if desired.

Next, and optionally, a base paint layer may be applied to the substrate surface or the chemical film treatment layer depending on the substrate material, for example, using a solvent or UV painting process. Again, a plasma treatment may be applied to the base paint layer once cured to ensure good adhesion to any layer applied thereon. Also, in some cases, an adhesive layer may be applied over the base paint layer.

Next, an image or print layer is applied to the base paint layer or optionally, to the substrate surface or chemical film treatment layer. The print layer may be applied using solvent or UV based printing or other techniques described herein or incorporated herein by reference. Again, a plasma treatment may be applied to the print layer once cured to ensure good adhesion to any layer applied thereon and, although not shown, in some cases, an adhesive layer may be applied over the print layer.

Next, a finish or top coat layer is applied to the print layer to seal the image created by these layers. For example, in some embodiments the coat layer is solvent based or a UV cured paint layer. In some cases, an industrial coating is applied as a top coat layer, for example, by UV curing coating machinery manufactured by Eodex Enterprises LTD of Taiwan. In some embodiments, a clear coat finish is applied as a top coat layer and formulated to be a high gloss, semi-gloss, matte or soft-touch finish.

Additionally, it is understood that the base paint layer, the print layer and the coat layer may use materials or be applied or formed using any of the materials, techniques, processes, technologies described herein or incorporated herein by reference, or as understood by those of ordinary skill in the art.

Furthermore, in some embodiments, the substrate itself may be a multi-layer substrate and/or have different surfaces prior to any imagery applied to either side. For example, in one embodiment, the substrate is a plastic, glass or metal substrate with a fabric, leather or other material substrate adhered thereto such that one surface of the substrate is plastic, glass or metal and the other surface of the substrate is fabric, leather or other material. Additional layers may be then added to achieve a desired appearance on the substrate.

In addition to the above embodiments, it should be understood that several methods are disclosed herein or are incorporated herein by reference for personalizing consumer products. For example, disclosed herein is a method for personalizing consumer products using 2D and/or 3D skins, method of installing 2D and/or 3D skins on a consumer product, and a method of applying a themed skin or skins to a consumer product via 2D and/or 3D skins.

With respect to on-demand customization, such skins or covers may be made and sold using either an “out of box” business model or an “in box” business model as described in U.S. patent application Ser. No. 13/103,997, filed May 9, 2011 and entitled “Systems and Methods of On Demand Manufacturing of Customized Products”, which is incorporated herein by reference. In either model a software management platform, or on-demand platform, may be provided that performs many of the functions described herein. An example of an on-demand platform primarily suited for the out of box model is described in U.S. patent application Ser. No. 11/935, 382, filed Nov. 5, 2007 and entitled “Order Fulfillment and Content Management Systems and Methods”, published as US Publication No. 2008/0154750, which is incorporated herein by reference.

While many embodiments described herein or incorporated herein by reference are primarily directed to the out of box model, one or more elements of the on-demand platform may also be applicable in the inbox model. Examples of pressure sensitive film, adhesive covers or adhesive materials to be applied to the reversible structure or portions thereof are described in: U.S. patent application Ser. No. 11/726,960, filed Mar. 23, 2007 and entitled “Adhesive Cover for Consumer Devices”, published as US Publication No. 2008/0233326; and U.S. patent application Ser. No. 11/759,600, filed Jun. 7, 2007 and entitled “Fishing Lures and Adhesive Cover for Same”, published as US Publication No. 2008/0104880, both of which are incorporated herein by reference.

An example of an interactive interface allowing a user to create a virtual design, for example, in creating imagery for application to products, portions thereof, accessories to products such as covers, shells and/or adhesive skins or materials in both the inbox and out of box models, is described in U.S. patent application Ser. No. 12/267,527, filed Nov. 7, 2008 and entitled “Customizing Print Content”, published as US Publication No. 2009/0122329, which is incorporated herein by reference.

An example of a path creation utility for use within an interactive image editor useful to allow a user to create customized image content by overlaying one or more images upon one or more background images to create or define a selected portion of the image content is described in U.S. patent application Ser. No. 12/684,781, filed Jan. 8, 2010 and entitled “Path Creation Utility for Image Editor”, which is incorporated herein by reference. One or more of the processes and systems described in one of more of these patent documents may be applied in one or more embodiments of processes implementing various inbox models and/or out of box models such as those described herein.

Optional material preparation parameters for metal or plastic parts include a pre-treatment (typically for metal), base coat, edge trim and/or powder coat. On demand direct to surface substrate printing options for metal or plastic parts, including keyboards, include color, graphics/images, texture (e.g., laser etched texture, topographical texture, printed texture through selective application of print layers), gloss matte, legend (localized), asset tag/barcode (either 2D or 3D barcode), and/or printable UV sealant. UV topcoat options for metal or plastic parts include gloss, semi gloss, matte and/or soft touch. It is understood that any other options such as described herein may also be included such as text, size, font, language, transparency, etc.

While the invention herein disclosed has been described by means of specific embodiments, examples and applications thereof, numerous modifications and variations could be made thereto by those skilled in the art without departing from the scope of the invention set forth in the claims.

What is claimed is:

1. A cover for a consumer product comprising:
a film substrate configured to cover at least a portion of a surface of the consumer product, the surface including a display screen, the film substrate being at least partially light transmissive and comprising a window portion configured to allow at least a portion of the display screen to be at least partially viewable therethrough; and
an image layer on another portion of the film substrate, the image layer configured to at least partially obscure an original appearance of the surface covered by the other portion of the film substrate;
wherein the film substrate and image layer cooperate to cover and protect the display screen and decorate the consumer product.

2. The cover of claim 1 further comprising an overlaminate layer covering the film substrate.

3. The cover of claim 1 wherein the image layer comprises a non-functional design element.

4. The cover of claim 1 wherein the image layer comprises a functional design element that cooperates with a function of the consumer product.

5. The cover of claim 1 wherein a portion of the image layer is on a portion of the window portion of the film substrate.

6. The cover of claim 1 wherein the image layer is not on the window portion of the film substrate.

7. The cover of claim 1 wherein the image layer substantially covers a non-window portion of the film substrate.

8. The cover of claim 1 wherein the image layer covers less than fully covers a non-window portion of the film substrate.

9. The cover of claim 1 wherein the image layer configured to obscure an original appearance of the surface covered by the other portion of the film substrate to decorate the consumer product.

10. A method comprising:
obtaining a film substrate that will cover at least a portion of a surface of a consumer product, the surface including a display screen, the film substrate being at least partially light transmissive and comprising a window portion configured to allow at least a portion of the display screen to be at least partially viewable therethrough; and
applying an image layer on another portion of the film substrate, the image layer configured to at least partially obscure an original appearance of the surface covered by the other portion of the film substrate;
wherein the film substrate and image layer will cooperate to cover and protect the display screen and decorate the consumer product.
